(19) United States
(12) Patent Application Publication
(10) Pub. No.: US 2020/0174520 A1
(43) Pub. Date: Jun. 4, 2020

(54) COMPUTER HOUSING

(71) Applicant: Fujitsu Client Computing Limited, Kawasaki (JP)

(72) Inventor: Wilhelm Neukam, München (DE)

(21) Appl. No.: 16/621,445

(22) PCT Filed: Jun. 12, 2018
(86) PCT No.: PCT/EP2018/065530

§ 371 Date: Dec. 11, 2019

(30) Foreign Application Priority Data
Jun. 14, 2017 (DE) 10 2017 113 146.9

(51) Int. Cl. G06F 1/16; G06F 1/18; H05K 5/02; G06F 21/86

(52) U.S. Cl. CPC G06F 1/1607; G06F 1/182; G06F 2200/1639; G06F 21/86; G06F 2200/1631; H05K 5/0208

(57) ABSTRACT

A computer housing includes a housing frame including a first cover and a second cover. The first and second covers are components of an outer housing wall removable from the housing frame and, in the mounted state, each covers an inner region of the computer housing to the outside. The first and second covers each have an operating mechanism to release an engagement of the first and/or second cover on the housing frame. In the mounted state, the first cover hides the operating mechanism of the second cover. When the first cover is removed, the operating mechanism of the still mounted second cover can be operated from outside. Thus, the engagement of the second cover can be released and the second cover can be removed from the housing frame.

### TECHNICAL FIELD

This disclosure relates to a computer housing including a housing frame and one or two covers that may be removed from the housing frame, wherein the one or two covers are portions of an outer housing wall, respectively, and, in a mounted state, cover an interior space of the computer housing, respectively, to the outside.

### BACKGROUND

Advantageously, computer housings are embodied in a way that an easy access to components within the computer housing, e. g. to wiring, add-on components, hard disks or any other storage components, is configured without having to use tools. Hereto, one or more covers at the computer housing that are removable components from an outer housing wall, may be removed from the computer housing or a housing frame. Thus, a user may access one or more interior spaces behind the computer housing and, thus, any components arranged in the one or more interior spaces. Traditional solutions have the disadvantage that the covers are not especially protected against any non-authorized or accidental opening, or the design of respective safety mechanisms is expensive.

It could therefore be helpful to provide a computer housing of the type mentioned above including at least one removable cover that prevents unwanted opening of the cover while enabling easy access to components within the computer housing without having to use tools.

### SUMMARY

I provide a computer housing including a housing frame including a first cover and a second cover, wherein the first and second covers are components of an outer housing wall that are removable from the housing frame and, in a mounted state, cover an interior space of the computer housing, respectively, to the outside, wherein the first and second covers each include an operating mechanism that releases engagement of the first or second covers, respectively, on the housing frame, the first and/or second covers are removable from the housing frame when the respective engagements are released, in a mounted state of the first and second covers, the first cover hides the operating mechanism of the second cover, and when the first cover is removed, the operating mechanism of the still mounted second cover is operable from outside such that the engagement of the second cover is releasable, and the second cover is removable from the housing frame.

I also provide a computer housing including a housing frame and a cover that is removable from the housing frame, wherein the cover is a component of an outer housing wall and, in a mounted state, covers an interior space of the computer housing to the outside, wherein the cover includes an operating mechanism that releases an engagement of the cover at the housing frame, and the cover is removable from the housing frame when the engagement is released, a safety pin is configured to couple the operating mechanism to a component of the housing frame that is fixed regarding the cover, and thereby locks the operating mechanism against any operation, and the safety pin is configured in a releasable way and the operating mechanism is unlocked when the safety pin is released.

### BRIEF DESCRIPTION OF THE DRAWINGS

FIG. 1 shows a perspective view of a computer housing in a first state.

FIG. 2 shows the computer housing according to FIG. 1 in a second state.

FIG. 3 shows the computer housing according to FIGS. 1 and 2 in a third state.

FIG. 4 shows a further example of the computer housing in the first state.

FIG. 5 shows the computer housing according to FIG. 4 in a second state.

### LIST OF REFERENCE SIGNS

1 Computer housing

2 Housing frame

3 First cover

4 Second cover

5 Stand

6 Operating mechanism of the first cover

7 Lock

8 Interior

9 Cable connection/plugs

10 Operating mechanism of the second cover

11 Resilient flap

12 Engaging means

13 Lever

14 Safety pin

15 Interior

16 Reception

17 Shield plate

18 Fastening means

19 Cable

20 Cable duct having a hole

21 Stand opening

22 Opening of the operating mechanism

23 Opening in the fixed portion of the housing frame

B Overlapping zone

### DETAILED DESCRIPTION

My computer housing comprises a housing frame, a first cover and a second cover. The first and second covers are components of an outer housing wall that may be removed from the housing frame and, in the mounted state, cover an interior space of the computer housing, respectively, to the outside. The first and second covers each comprise an operating mechanism that releases an engagement of the first and second covers at the housing frame, respectively. In each of the released engagements, a first and/or second cover may thus be removed from the housing frame.

In the mounted state of the first and second covers, the first cover hides the operating mechanism of the second cover. When the first cover is removed, the operating mechanism of the still mounted second cover may be operated from outside. Thus, the engagement of the second cover may be released and the second cover may be removed from the housing frame.

In such a computer housing, the first cover blocks operation of the second cover if the first cover is mounted at the housing frame. This is achieved in a way that in a mounted state of the first and second cover, the first cover hides the operating mechanism of the second cover. This way, the operating mechanism of the second cover is not operable. Thus, the second cover may not be released from engagement at the housing frame and removed from the housing frame. This way, the mounted first cover protects the mounted second cover against unwanted opening. Due to such an enforced coupling of the first and second cover and/or the operating mechanism of the second cover to the first cover it is thus prevented that the second cover is removable from the housing frame if the first cover is mounted at the housing frame. Thus, my solution enables a very simple protection of the second cover against unwanted removing from the housing frame.

The computer housing may be a computer housing of a so-called all-in-one-computer, wherein the functionality of the computer is integrated within the display housing or monitor housing (in addition to the actual display or monitor). Such all-in-one-computers are becoming more and more widespread. In all-in-one-computers often an easy access to components within the computer housing is required without having to use tools to replace predetermined components or upgrade the computer system with predetermined components. Especially in a use case for an all-in-one-computer, however, not limited to the use case, the computer housing described above is advantageous.

It is possible that in an interior in the computer housing covered by the second cover, components, for example, hard disks or other storage component that have to be protected in a dedicated way, are accommodated. The second cover covers such kind of components to the outside, thus no direct access to said components is possible when the first cover is mounted to the housing frame. This way, the components in the interior covered by the second cover are protected against unauthorized or unwanted access, in a simple way.

In a mounted state, the first cover may be securable by a lock at the housing frame. Thus, the first cover may not be removed from the housing frame in a secured state. This enables locking the first cover at the housing frame. Thus, also, the second cover is indirectly locked as the operating mechanism of the second cover, as described above, is hidden by the first cover in a way that it cannot be operated, and the second cover cannot be removed from the housing frame. Only when the lock at the first cover is released and, thus, the first cover is released, may it be removed from the housing frame by operating an operating mechanism physically by releasing the engagement of the first cover.

This way, the operating mechanism of the second cover is exposed and may be operated in an adequate way to also remove the second cover from the housing frame, if required. By locking the first cover by a lock, an especially save configuration of the computer housing is thus ensured to protect the first and also the second cover. The lock is, for example, a Kensington lock.

The first cover may be pivotable regarding the housing frame to cover it, while the second cover may be displaceable regarding the housing frame to remove it. By configuring different movement trajectories for the first and second cover, a manipulation for an unauthorized opening of the second cover may be prevented when the first cover is mounted. Even though the first cover is locked by the lock, described above, at the housing frame, for example, a partially forced opening of the first cover, for example, by bending the first cover does not inevitably lead to the possibility to also force the second cover by a respective analog movement into an opened position. Rather, by using different movement trajectories for the first and second covers, it may be achieved that the movement of the second cover is not possible even when a partial movement of the first cover is forced by manipulation by using a tool, for example

Alternatively to the example describe above, the first cover is slidable regarding the housing frame to remove it, while the second cover is pivotable regarding the housing frame to remove it.

My computer housing comprises a housing frame and a cover that is removable from the housing frame. The cover is a component of an outer housing wall and, in the mounted state, covers an interior space of the computer housing, respectively, to the outside. The cover comprises an operating mechanism to release engagement of the cover at the housing frame, wherein the cover may be removed from the housing frame when the engagement is released.

In addition, a safety pin is configured to connect the operating mechanism to a portion of the housing frame, which is fixed regarding the cover, and locks the operating mechanism against any operation. The safety pin is configured in a releasable way, wherein the operating mechanism is unlocked, when the safety pin is released.

A computer housing configured in this way may prevent an unwanted removal of the cover. The safety pin locks the operating mechanism in the mounted state of the safety pin against an operation, thus an engagement of the operating mechanism at the housing frame may not be released and the cover may not be removed from the housing frame. Rather, the operating mechanism may only be operated, if the safety pin is released, that is, removed. This way, the safety pin represents an additional safety measure which has to be overcome to actuate an operating mechanism to remove the cover. Such a computer system is safe, but also easy to handle.

In the mounted state, the safety pin may penetrate through an opening at the operating mechanism into an opening at the fixed portion of the housing frame and fixes the operating mechanism at the fixed portion of the housing frame. This way, the safety pin creates a safe connection between the operating mechanism and the fixed portion of the housing frame, thus the operating mechanism is locked against any operation. The safety pin may be formed in a way that it overcomes a resistance when plugged into the opening, and engages in an end position at the fixed portion of the housing frame. Thus, the safety pin is fixed in said position at the fixed portion of the housing frame. For example, the safety pin comprises a lateral bulge that may be pressed into the opening of the fixed portion of the housing frame only by using a predetermined pressure force. Alternatively, the safety pin comprises a lateral depression corresponding to a respective negative form at the fixed portion of the housing frame, and may also only be pressed into the opening at the fixed portion of the housing frame by a predetermined pressure force.

To establish respective resistance or pressure forces to keep the safety pin in the opening at the fixed portion of the housing frame in a safe way, coupling members as, for example, gaskets, washers and the like may be used.

Alternatively or complementarily, the safety pin and the opening may be configured at the fixed portion of the housing frame as a key-lock-connection. Thus, the safety pin is inserted in a predetermined position into the opening at the fixed portion of the housing frame and twisted, for example. Thus, the safety pin is fixed at the fixed portion of the housing frame in the opening. In this example, the safety pin may be released from the fixed portion of the housing frame again by turning the safety pin back into the first initial position. This comprises a plurality of examples and combinations of the features described above.

The computer housing may be embodied as a computer housing according to the first example described above. According to a second example, the removable cover of the computer housing is configured as the second cover of the computer housing according to a first example. The safety pin is configured to respectively lock the operating mechanism of said second cover against any operation. Said embodiments thus represent a combination of the two computer housings according to a first and second example

In those examples, the operating mechanism of the second cover is thus protected twice. A first protection results from the fact, as described above, that in the mounted state, the first cover covers the operating mechanism of the second cover. Thus, it may not be operated from outside. The second protection of the operating mechanism of second cover results from the fact that, in the mounted state, the safety pin also locks the operating mechanism of the second cover against any operation. This way, the operating mechanism of the second cover may only be operated when the first cover is removed (exposing of the operating mechanism of the second cover), and when the safety pin is released (unlocking the operating mechanism of the second cover). Thus, the operating mechanism of the second cover is protected against an unwanted opening of the second cover in a redundant way and in an especially simple, but effective way. However, removing the second cover may be implemented in a simple way, by removing the first cover, and releasing the safety pin.

In the computer housing combined according to the first and second examples, in the mounted state of the first and second covers, the first cover hides the safety pin, wherein the safety pin may be released from outside if the first cover is removed. That means, that safety pin is not releasable from outside if the first cover is mounted, as it hides the safety pin in the mounted state. By this configuration, the operating mechanism of the second cover is especially protected against an unwanted removal of the second cover in manipulations at the first cover or the operating mechanism of the first cover. In particular, in a statewhere the first cover is locked by a lock or secured at the housing frame (see description above), this way, a manipulative opening or removal of the second cover is severely impeded or prevented.

Even when a small gap between the first cover and the housing frame may be opened at the locked or secured first cover by a respective tool (for example, by a flat steel or screwdriver) (for example, due to flexibility of the plastic material of the first cover), thus an operation of the operating mechanism of the second cover would also become possible (for example, by a tool as a flexible flat steel or the like), but the safety pin prevents the respective operation of the operating mechanism of the still mounted second cover from outside, as the safety pin remains hidden by the first cover (despite manipulations) in a way that safety pin may not be released. Preferably, the computer housing is configured in a way that the safety pin may only be removed when the first cover has been completely opened or removed. This way, the manipulation possibilities mentioned above are further impeded.

Further advantages and configurations are disclosed below. My housings are described in the following by examples with reference to a plurality of figures,

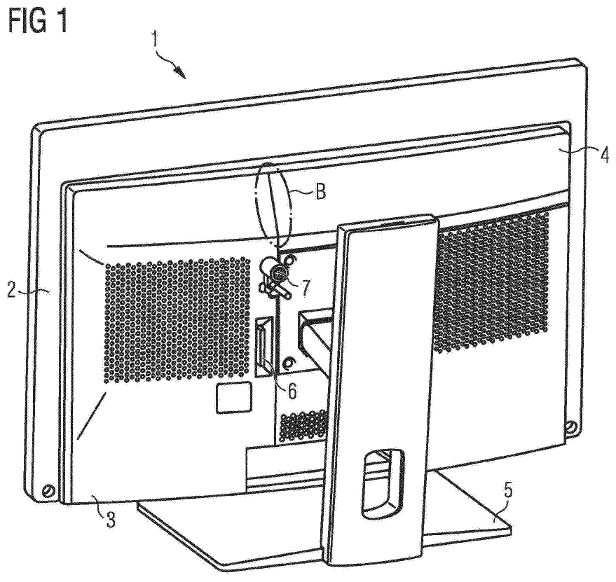

FIG. 1 shows the computer housing 1 which is a computer housing of an all-in-one computer. That means that the computer housing 1 is a display or monitor comprising a stand 5 and, in addition to a display unit of the display or monitor, dedicated components of the computer are integrated in the computer housing 1. This way, the system provides a computer that is directly integrated into the housing of the monitoring or display. However, in alternative examples, the computer housing 1 may also be configured as a desktop computer housing or as a server housing or the like, for example

The computer housing 1 according to FIG. 1 comprises a housing frame and a first cover 3 and a second cover 4. The first and second covers 3, 4 may be removed from the housing frame 2, and hide an interior space of the computer housing 1, respectively, in which components of the computer housing are accommodated. For example, the first cover 3 hides an interior space that accommodates cables, cable ports or plugs therein, while the second cover covers an interior space that receives hard disks, disk drives or other storage components therein. This will be described in the following figures in detail.

The first cover 3 may be operated by an operating mechanism according to FIG. 1. By operating the operating mechanism 6, an engagement of the first cover 3 at the housing frame 2 may be released. Thus, the first cover 3 may be removed from the housing frame 2. For example, the operating mechanism 6 is a handle or lever that may be operated by a user. The operating mechanism 6 may, for example, be a spring. Thus, the first cover 3 engages in a stable end position in the closed or mounted state, which is shown in FIG. 1. When operating the operating mechanism 6 against a spring force, the engagement may be released. Thus, the first cover 3 may be moved. In the example according to FIG. 1, the first cover 3 is pivotable regarding the housing frame 2.

The first cover 3 may be secured or locked by a lock 7 at the housing frame 2. In the example according to FIG. 1, the lock 7 is a Kensington lock. By the lock 7, the first cover 3 may thus be locked in a way that even when operating the operating mechanism 6, the first cover may not be removed out of engagement thereof at the housing frame 2 or only by a very small amount. In any event, in the locked state, a removal or complete opening of the first cover 3 is prevented by the lock 7.

The computer housing 1 according to FIG. 1 is further configured in a way that the first cover 3 hides or covers a further operating mechanism (not shown) of the second cover 4 in a portion B. This way, in a state according to FIG. 1, the second cover 4 may not be operated, as the first cover 3 prevents the respective operation by hiding the operating mechanism of the second cover 4 in portion B. This way, it is prevented that the second cover 4 may be released from the engagement thereof at the housing frame 2, and may be removed from the housing frame 2 if the first cover 3 is in a state according to FIG. 1. Thus, a computer housing 1 according to FIG. 1 protects the second cover 4 against any unwanted removal from the housing frame 2, when the first cover 3 is still mounted. This is, for example, useful if the second cover 4 hides safety-critical components as, for example, storage components, wherein, by the configurative examples of the type described, an opening of the second cover 4 may be prevented when the first cover 3 is closed. Thus, access to the safety-critical components from outside is prevented. This way it may prevented, for example, that an unauthorized user removes the second cover 4, although the first cover 3 is closed or engaged by the lock 7, and thus gains access to safety-critical components. By an enforced coupling of the first and second covers 3 and 4, a simple but also effective mechanism is created to protect the second cover 4.

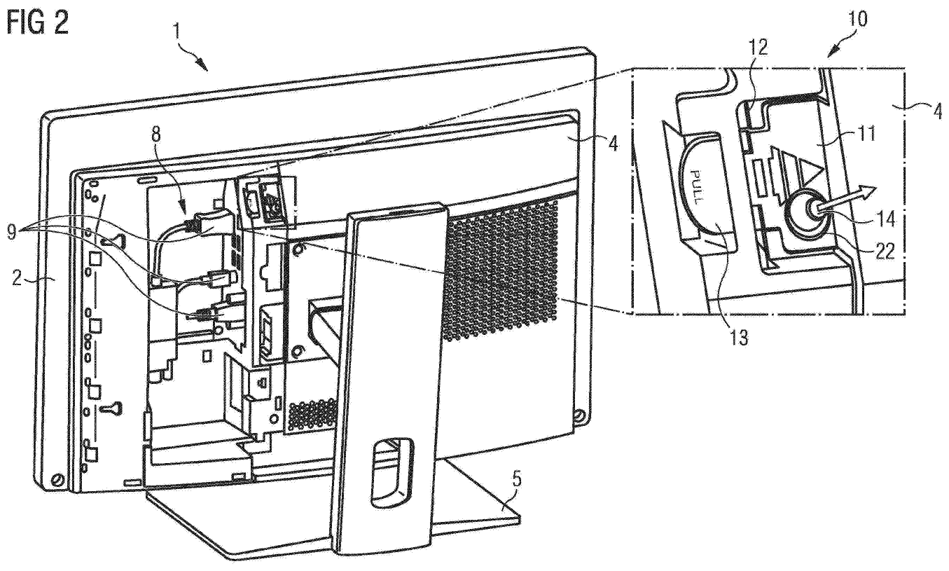

FIG. 2 shows the computer housing 1 according to FIG. 1 in a second state. In that state, the first cover 3 is removed according to FIG. 1. FIG. 2 illustrates an interior space 8 hidden by the first cover 3 according to FIG. 1. In the interior space 8, various cable connections or plugs 9 of a cabling within the computer housing 1 are configured. The cable connections or plugs 9 are used to connect components of the all-in-one-computer of the kind described above by cables.

Due to the removed first cover 3 according to FIG. 2, the additional operating mechanism 10 of the second cover 4 is exposed. The operating mechanism 10 is again illustrated in an enlarged partial view of the right side of FIG. 2 in detail. The operating mechanism 10 comprises a resilient flap 11 that may be operated by a user by a lever 13. In the mounted state of the second cover 4 as illustrated in FIG. 2, the resilient flap 11 engages with an engagement means 12 which is in the example according to FIG. 2 as an edge for engagement with an opposite edge of the resilient flap 11 from behind. This means that, in the state of the second cover 4 illustrated according to FIG. 2, the resilient flap 11 snaps in behind the edge or the engagement means 12, and fixes the second cover 4 to the position shown. In this state, no movement of the second cover 4 is possible. For example, the second cover 4 is configured in a way that it is slidable to the right side regarding the housing frame 2 according to FIG. 2, when an engagement of the resilient flap 11 is released from the engagement means 12. Such a movement is prevented by the combination of the resilient flap 11 with the engagement means 12 in a state illustrated in FIG. 2. By operating the lever 13, the engagement connection between the components 11 and 12 may be released (for example, by pulling the lever 13 in a direction out of the drawing plane of FIG. 2). In that example, a user may slide the second cover 4 rightwards regarding the housing frame 2 according to FIG. 2, and remove the second cover 4 from the housing frame 2.

In the configuration of the computer housing 1 shown in FIG. 2, operation of the operating mechanism 10 is in addition protected by safety pin or pin 14. In the state shown in FIG. 2 (see, in particular, the enlarged detail view), the pin 14 is disposed in a way that it penetrates through an opening 22 at the resilient flap 11 into an opening (not shown) on the fixed portion of the housing frame 2. This way, the pin 14 blocks an operation of the operating mechanism 10 by the lever 13. To operate the operating mechanism 10, first pin 14 has to be pulled out in the direction of the arrow to release the lock of the operating mechanism at the portion of the housing frame 2, which is fixed regarding cover 4. This way, the operating mechanism 10 is in addition protected against unwanted operation in addition to the fact that, in the mounted state, the operating mechanism 10 hides the first cover 3 according to FIG. 1, and may not be accessed. Furthermore, in such a state, pin 14 is also hidden (see the states according to FIGS. 1 and 2). Thus, in a mounted state of the first cover 3, pin 14 is also not releasable from the engagement thereof with the operating mechanism 10 or the housing frame 2.

Thus, the pin 14 prevents operation of the operating mechanism 10 by the lever 13 even when the first cover 3 is manipulated by a tool, when the first cover 3 is mounted according to FIG. 1. Even when the first cover 3 is locked by the lock 7 according to FIG. 1, a small gap may possibly be opened between the first cover 3 and the housing frame 2 (for example, adjacent to the operating mechanism of the first cover 3). For example, an unauthorized user may bend up the first cover 3 by using a respective tool (flat steel, screwdriver or the like) despite a lock by the lock 7 to get access to the operating mechanism 10 of the second cover 4 and operate it to remove the second cover 4. However, in this example, pin 14 blocks operation of the operating mechanism 10, wherein the pin 14 is positioned in a way that, in the state shown in FIG. 2, even when the first cover 3 has been bent up, the pin 14 may not be released from outside. Thus, the configuration of the computer housing 1 according to FIGS. 1 and 2 represents a multi-tier protection of the second cover 4 against unwanted removal, even for manipulations on a locked and secured first cover 3.

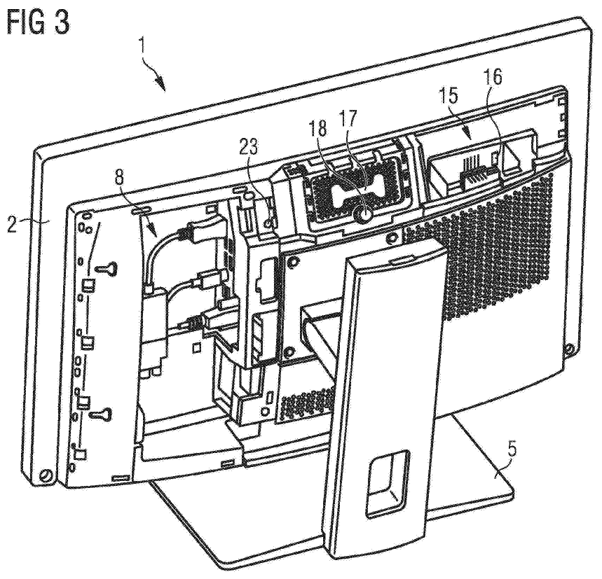

FIG. 3 shows the computer housing 1 in a third state in which both the first cover 3 and also the second cover 4 are removed from the housing frame 2. Removing the second cover 4 is performed by removing the pins 14 and releasing the resilient flap 11 by a lever 13 from the engagement means 12 as described above regarding to FIG. 2.

In FIG. 3, both covers 3 and 4 are removed, wherein both interior spaces 8 and 15 are opened to the outside. According to FIG. 3, the interior space 15 shows a reception 16 opened to the outside and may be accessed. The reception 16 is, for example, configured to receive hard disks or other drives. In addition to the reception 16, the interior 15 also comprises a further portion including a shield plate 17 configured to shield the components behind. The components arranged behind the shield plate 17 may, for example, comprise storage components as, for example, flash memory. To access the components, a releasable fastening means 18 may be removed from the shield plate 17. Thus, the shield plate 17 may be removed. The offering means 18 is a knurled screw, for example. Besides additional protection against a direct access to the components behind, the shield plate 7 provides an electrostatic or electromagnetic shielding of the components arranged behind. This way, a very good electromagnetic compliance (EMV) of the system may be achieved.

As illustrated in FIG. 3, an opening 23 is exposed at the fixed portion of the housing frame 2 in the region of a reception of the operating mechanism 10 according to FIG. 2, after pin 14 (see FIG. 2) has been removed from the opening 23. In the state of the computer housing 1 illustrated according to FIG. 3, access to components in the interior space 8 and also components in the interior space 15 of the computer housing 1 is possible after both covers 3 and 4 has been removed. For example, a user may configure cable connections or plugs 9 in the interior space 8, for example, replug and/or upgrade the system by components in the interior space 15 or replace components in the interior 15.

To close the computer housing 1 again, for example, after the respective work has been performed, first the second cover 4 is pushed onto the housing frame 2 from the right side according to FIG. 3, until the resilient flap 11 according to FIG. 2 engages with the engagement means 12 from behind and snaps in according to the state shown in FIG. 2. Then, according to FIG. 2, pin 14 is again inserted through the opening 22 in the resilient flap 11 into the opening 23 (see FIG. 3), whereby the operating mechanism 10 is secured again according to FIG. 2. Then, the first cover 3 is again mounted to the housing frame 2 and pivoted back in the state shown in FIG. 1. Thus, the operating mechanism 6 according to FIG. 1 engages the first cover 3 at the housing frame 2. In the state according to FIG. 1, thus the operating mechanism 10 of the second cover 4 and the pin 14 are again hidden by the first cover 3 in portion B, thus an operation of the second cover 4 or a removal of the pin 14 is not possible. The first cover 3 may then again be locked by the lock 7. Thus, the complete housing wall of the computer housing 1 is protected against any unwanted access from outside in a redundant way.

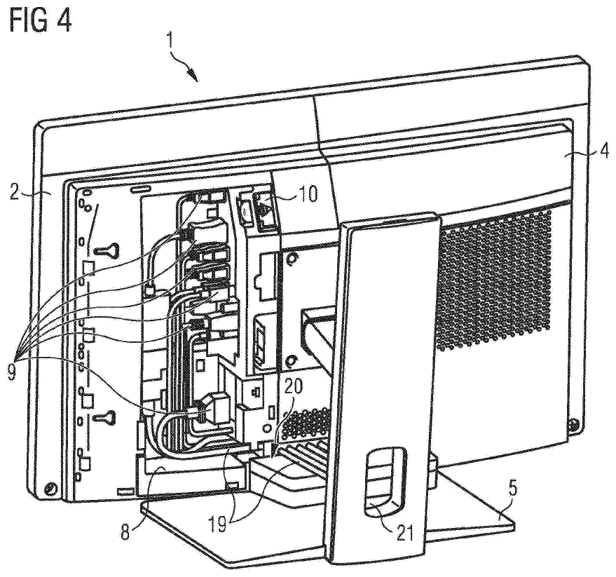

FIG. 4 shows a further example of the computers housing 1, wherein the first cover 3 has already been removed. However, the second cover 4 is still at the housing frame 2. The example according to FIG. 4 differs from the example according to FIGS. 1 to 3 in a way that a securement of the operating mechanism 10 of the second cover 4 by a pin 14 (see FIG. 2) is omitted. According to the example of FIG. 4, a protection of the second cover 4 is achieved only due to the fact that, in a mounted state, a mounted first cover 3 (not shown) hides the operating mechanism 10 of the second cover 4 as shown in FIG. 1 and as has been described above.

The example according to FIG. 4 illustrates a cable duct of the cable connections or plugs 9 in the interior space 8 of the computer housing 1. Hereby, the cables 19 extend away from the cable connections or plugs 9, and are routed downwards from the cable connections or plugs 9 which are laterally connected to a centralized board, in the direction of the stand 5, and from there towards a centralized cable duct 20 having an opening to the outside. This way, the cables 19 may be guided from the interior space 8 via the cable duct 20 to the outside. An additional opening 21 of stand 5 allows to route the cables 19 through the stand 5 towards the rear side of the computer housing 1. The cables 19 may be cables from peripheral devices, for example, which in the interior space 8 are connected to system components within the computer housing 1 by cable connections or plugs 9. This way, besides the described aspects of a safe closing of both covers 3 and 4 also an intelligent cable routing concept is realized within the computer housing 1. In addition, the setup of cable connections or plugs 9 arranged laterally on a centralized system board within the computer housing 1, also provides the advantage that the cable connections or plugs 9 and the cables 19 thereof are easy to access and handle when the interior space 8 is opened. This way, the cable connections or plugs 9 may be plugged in or plugged off in a simple way, and the cables 19 may be routed without conflicting with the stand 5 and the support for the holder of the monitor or of the system. Compared to traditional all-in-one-computers or monitors, wherein the cable connections are arranged downwards to the stand 5 or towards a rear side, this also provides the advantage of an enhanced handling, as the stand 5 is not conflicting with cable connections or plugs 9 nor has to be dismantled to establish the respective connections.

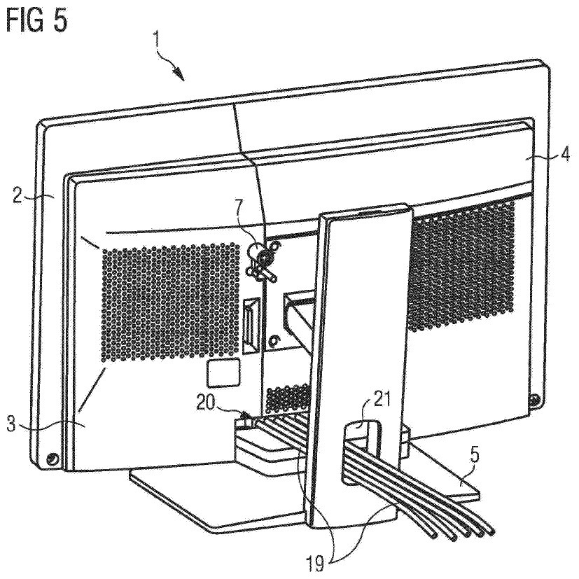

Finally, FIG. 5 illustrates the arrangement according to FIG. 4 when the first cover 3 is closed, which again is locked by a lock 7. The cables 19 are routed via the cable duct 20 to the outside of the computer housing 1, and penetrate through the opening 21 in stand 5. This results in a simple cable management at the computer housing 1.

The illustrated configurations represent only examples. However, the computer housings 1 described enable a simple, but effective protection of a cover 4 on the computer housing 1 against any unwanted or unauthorized access to components arranged behind the cover 4 in an interior space 15. The cover 4 is here protected by an additional cover 3 or by a pin 14 in a way that the operating mechanism 10 thereof is hidden by the cover 3 in the mounted state thereof, or the operation thereof is locked by pin 14. To remove the cover 4, only the additional cover 3 has to be removed or the pin 14 has to be pulled out. Thus, the operating mechanism 10 of the cover 4 is actuated and the cover 4 may be removed from the housing frame 2.

In further examples of a computer housing 1, only a cover 4 is provided which may be secured by a pin 14 according to the description above. In that example, a second cover 3 for an additional protection of the cover 4 (hiding an operating mechanism 10 of the cover 4) may be omitted.

1.-10. (canceled)

11. A computer housing comprising a housing frame including a first cover and a second cover, wherein the first and second covers are components of an outer housing wall that are removable from the housing frame and, in a mounted state, cover an interior space of the computer housing, respectively, to the outside,
wherein the first and second covers each comprise an operating mechanism that releases engagement of the first or second covers, respectively, on the housing frame,
the first and/or second covers are removable from the housing frame when the respective engagements are released,
in a mounted state of the first and second covers, the first cover hides the operating mechanism of the second cover, and
when the first cover is removed, the operating mechanism of the still mounted second cover is operable from outside such that the engagement of the second cover is releasable, and the second cover is removable from the housing frame.

12. The computer housing according to claim 11, wherein, in a mounted state, the first cover is lockable by a lock at the housing frame such that it is not possible to remove the first cover from the housing frame in the locked state.

13. The computer housing according to claim 11, wherein the first cover is pivotable regarding the housing frame to remove it, while the second cover is slidable regarding the housing frame to remove it.

14. The computer housing according to claim 11, wherein the operating mechanism of the second cover comprises a resilient flap and an engagement means, in the mounted state, the resilient flap is engaged with the engagement means, and the engagement of the resilient flap with the engaging means is releasable by operating the resilient flap against a spring force.

15. The computer housing according to claim 11, herein the interior space that is covered by the second cover comprises a shield plate that shields the components accommodated in the interior space to the outside.

16. The computer housing according to claim 15, wherein the shield plate is fixed by releasable fastening means at the housing frame, and the shield plate may be removed from the housing frame by releasing the fastening means when the second cover is removed.

17. A computer housing comprising a housing frame and a cover that is removable from the housing frame, wherein the cover is a component of an outer housing wall and, in a mounted state, covers an interior space of the computer housing to the outside,
wherein the cover comprises an operating mechanism that releases an engagement of the cover at the housing frame, and the cover is removable from the housing frame when the engagement is released,
a safety pin is configured to couple the operating mechanism to a component of the housing frame that is fixed regarding the cover, and thereby locks the operating mechanism against any operation, and
the safety pin is configured in a releasable way and the operating mechanism is unlocked when the safety pin is released.

18. The computer housing according to claim 17, wherein, in the mounted state, the safety pin penetrates through an opening at the operating mechanism into an opening at the fixed portion of the housing frame and fixes the operating mechanism at the fixed portion of the housing frame.

19. The computer housing according to claim 17, wherein the releasable cover is configured as the second cover, and the safety pin is configured to respectively lock the operating mechanism of the second cover against any operation.

20. The computer housing according to claim 19, wherein, in the mounted state of the first and second cover, the first cover hides the safety pin, and when the first cover is removed, the safety pin is releasable from outside.

21. The computer housing according to claim 12, wherein the first cover is pivotable regarding the housing frame to remove it, while the second cover is slidable regarding the housing frame to remove it.

22. The computer housing according to claim 12, wherein the operating mechanism of the second cover comprises a resilient flap and an engagement means, in the mounted state, the resilient flap is engaged with the engagement means, and the engagement of the resilient flap with the engaging means is releasable by operating the resilient flap against a spring force.

23. The computer housing according to claim 13, wherein the operating mechanism of the second cover comprises a resilient flap and an engagement means, in the mounted state, the resilient flap is engaged with the engagement means, and the engagement of the resilient flap with the engaging means is releasable by operating the resilient flap against a spring force.

24. The computer housing according to claim 12, wherein the interior space that is covered by the second cover comprises a shield plate that shields the components accommodated in the interior space to the outside.

25. The computer housing according to claim 13, wherein the interior space that is covered by the second cover comprises a shield plate that shields the components accommodated in the interior space to the outside.

26. The computer housing according to claim 14, wherein the interior space that is covered by the second cover comprises a shield plate that shields the components accommodated in the interior space to the outside.

27. The computer housing according to claim 18, wherein the releasable cover is configured as the second cover, and the safety pin is configured to respectively lock the operating mechanism of the second cover against any operation.
